(19) United States
(12) Patent Application Publication
(10) Pub. No.: US 2005/0258973 A1
(43) Pub. Date: Nov. 24, 2005

(54) Smoke detector with fire drill system

(75) Inventors: Kevin Bruce Black, Roswell, GA (US); Matthew Anthony Ferris, Atlanta, GA (US)

Correspondence Address: AKERMAN SENTERFITT, P.O. BOX 3188, WEST PALM BEACH, FL, 33402-3188, US

(73) Assignee: Kidsmart Corp., Roswell, GA (US)

(21) Appl. No.: 10/851,598

(22) Filed: May 21, 2004

(51) Int. Cl. G08B 17/10

(52) U.S. Cl. 340/628; 340/516

(57) ABSTRACT

A smoke detector having fire drill system that includes a delay period. The fire drill system enables a user to actuate a fire drill and leave a room in which the smoke detector is located before an audible alarm is produced by the smoke detector. In at least one application, the fire drill system enables a parent to determine whether an alarm produced by a smoke detector is capable of awakening a sleeping child.

### FIELD OF THE INVENTION

The invention is directed generally to smoke detectors, and more particularly, to smoke detectors capable of producing audible alarms.

### BACKGROUND

There exist numerous types of smoke detectors. Some smoke detectors produce an audible alarm, such as an alarm generated from a buzzer or a speaker, while other smoke detectors produce a visual alarm. The success of smoke detectors with audible alarms in awakening sleeping people correlates directly with the quality of the sound generated by the smoke detector and the type of audible alarm produced. For instance, recent tests have shown that children experience deeper stages of non-rapid eye movement (NREM) sleep, particularly at stages three and four, than adults and have higher arousal thresholds. As a result, more often than not, children sleep through the alarms, such as buzzers and sirens, found in conventional smoke detectors. These tests have also shown that children are very likely to wake up from a deep sleep when they hear the voice of one of their parents.

As a result of these tests, smoke detectors capable of replaying voice recordings have been developed that enable parents to record their voice on a smoke detector so that when the smoke detector detects the presence of smoke, the smoke detector plays the recorded, familiar voice of a parent instructing the child to wake up and leave the room as previously taught. Smoke detectors such as these have proven to be more successful in awakening sleeping children than conventional smoke alarms.

Many conventional smoke detectors include a test feature that enables a smoke detector's functionality to be tested by depressing a button causing the smoke detector to immediately produce an audible alarm. The test feature has been used in conventional smoke detectors as a battery test function and a test of the operation of the smoke detectors. However, such conventional test features are inadequate to perform a fire drill. More specifically, a fire drill is most successful when occupants of a home are not aware that a fire drill is occurring and the occupants are able to be observed without being obstructed. However, such observation is not possible with conventional smoke detectors because conventional smoke detectors produce an audible alarm instantly upon depression of a test button. Thus, occupants of a room are not capable of being observed without interference by the person actuating the test feature. Thus, a need exists for a smoke detector enabling a fire drill to be performed.

### SUMMARY OF THE INVENTION

The invention is directed to a smoke detector for detecting smoke and creating at least an audible alarm for informing occupants of a home of the existence of a fire. The smoke detector includes a fire drill system enabling the smoke detector alarm to operate to determine whether the alarms are sufficiently loud and sufficient to awakening sleeping occupants in the room. The fire drill system, once actuated, delays producing an audible alarm enabling a person who actuated the fire drill to leave the room and observe the reaction of the occupants. In at least one embodiment, the smoke detector may be capable of playing a recorded message alerting occupants of detection of smoke and instructing the occupants to exit the room and structure.

The smoke detector may include a sound producing device for producing an alarm, a detection device for identifying the presence of smoke, and a control system for controlling the sound producing device. The control system may be capable of cycling the smoke detector through a fire drill by receiving input to start the fire drill, such as by a user depressing a button. Once the fire drill has been started, the smoke detector cycles through a delay period in which the smoke detector remains silent or substantially silent. During the delay period, the smoke detector may indicate that the smoke detector is operating in the fire drill mode with a visual indicator, such as a flashing light. The delay period enables a user to actuate the fire drill system of the smoke detector and leave the room in which the smoke detector is located before the audible alarm is produced. The delay period is advantageous because it allows a person to observe a sleeping occupant's real life reaction to the alarm to determine whether the smoke detector adequately awakens a sleeping occupant and how closely the occupant follows the escape plan. For instance, the fire drill system may be actuated by a user, such as a parent, without awakening a sleeping child. The parent may then exit the room and observe the child or children in the room from a hidden vantage point.

At the conclusion of the delay period, the audible alarm begins. The audible alarm may cycle through the fire drill to its pre-established conclusion or may be terminated early. The audible alarm may be a monotone or multitone alarm, a repetitive sound, a recorded message, or other appropriate alarm. A visual alarm, such as, but not limited to, a flashing light, an alternating pattern of flashing light, or other appropriate visual alarm may be emitted by the smoke detector during the fire drill. In at least one embodiment, the visual alarm produced by the smoke detector during the fire drill is different from the visual indicator emitted during the delay period. The fire drill may be conducted one or more times at the user's discretion.

The fire drill system is advantageous because the delay period included within the fire drill enables one who actuated the fire drill to leave the room in a controlled fashion without awakening a sleeping occupant of the room rather than having the alarm sound as the fire drill is actuated as found in the functionality test feature of conventional smoke detectors. In addition, the person actuating the fire drill is able to view the occupant's reaction to the fire alarm from a remote or hidden location to more accurately simulate an emergency condition in which smoke has been detected by the smoke detector. If a sleeping child is awakened by a fire alarm only to find the parent standing in the room, the child will simply ask the parent what is going on rather than leaving the room as though a fire were actually in the house. Thus, it is very important to determine how a sleeping occupant will respond to a fire alarm before an actual emergency condition occurs so that the potential loss of life from fire can be prevented.

These and other advantages and embodiments of the invention are described below.

### BRIEF DESCRIPTION OF THE DRAWINGS

The accompanying drawings, which are incorporated in and form a part of the specification, illustrate preferred embodiments of the presently disclosed invention(s) and, together with the description, disclose the principles of the invention(s). These several illustrative figures include the following:

FIG. 1 is a perspective fontal view of a smoke detector including aspects of this invention;

FIG. 2 is an exploded view of FIG. 1; and

FIG. 3 is a perspective rear view of the a smoke detector including aspects of this invention.

### DETAILED DESCRIPTION OF THE INVENTION

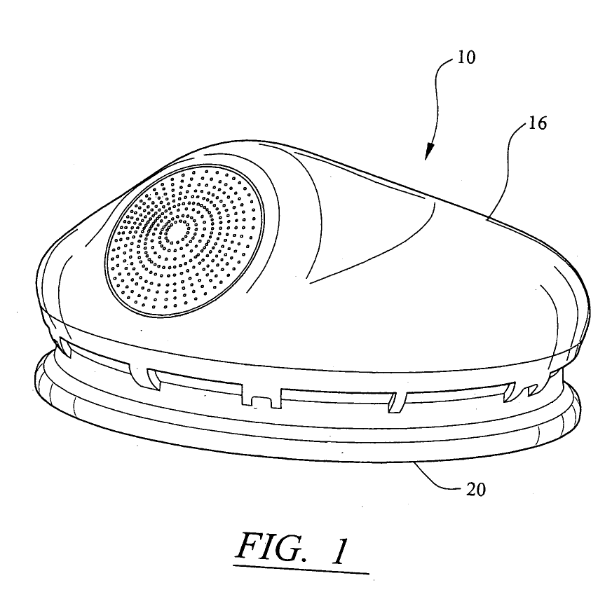

This invention is directed to a smoke detector 10, as shown in FIGS. 1-3, usable to produce one or more alarms when smoke is detected by the smoke detector 10. The smoke detector 10 includes a fire drill system enabling a user to actuate a fire drill and leave a room during a delay period before an audible alarm is produced by the fire drill so the user can determine whether the audible alarm produced by the smoke detector 10 is capable of waking a sleeping person, such as a child, and whether that sleeping person responds appropriately to the alarm.

The smoke detector 10 includes a sound producing device 12 for producing an alarm. The alarm may be an audible alarm, such as, but not limited to, a monotone or multitone sound, a repetitive sound including a single sound or multiple different sounds, a recorded human voice, or other appropriate alarm. The alarm may also include visual alarms, such as lights, that may or may not flash, or other appropriate visual alarms. In at least one embodiment, at least a portion of the alarm may be formed from a recorded message from a parent. The sounds producing device 12 may be, but is not limited to, a speaker, a buzzer, or other appropriate sound producing device.

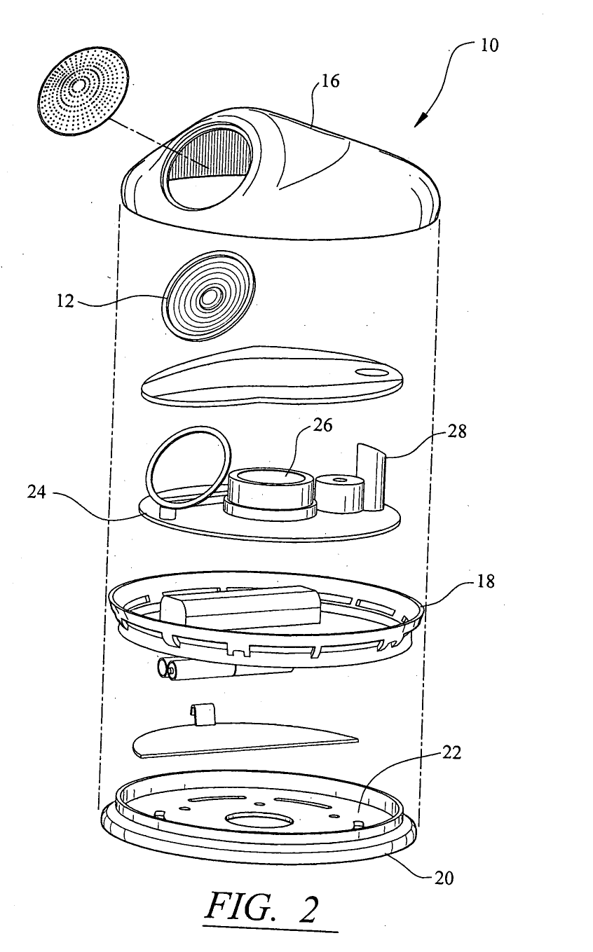

As shown in FIG. 2, the smoke detector 10 may be a smoke detector capable of being mounted attached to a wall, ceiling, or other structure in a building or may be releasebly attached to a bracket 20 that is configured to be attached to a wall, ceiling, or other structure, and may include a housing 16 adapted to be coupled to a base 18. The housing 16 may be formed from any appropriate shape enabling the housing 16 to fit on the base 18. The housing 16 may be formed from materials, such as but not limited to, plastics and metals. The base 18 may include a connection device 22 enabling the base 18 to be releaseably connected to the bracket 20. The bracket 20 may include a plurality of holes enabling the bracket 20 to be screwed to a surface. Alternatively, the base 18 maybe configured to be attached directly to a supporting surface, such as a ceiling.

The base 18 may also be configured to accept a control system 24. The control system 24 may include a detection device 26 for detecting smoke, a microcontroller 28, and other devices. The detection device 26 may be, but is not limited to being, an ionization detector, a photoelectric detector, or other appropriate detector. The microcontroller 28 may be programmable and capable of storing one or more alarm messages to be played when an alarm condition is recognized by the detection device 26, or when a fire drill is run, such as by a user depressing a button. The microprocessor 28, the sound producing device 12, and other electrical components may be powered by batteries contained in the smoke detector 10, municipal power supplies, solar energy systems, or other power sources.

In at least one embodiment of the invention, the microcontroller 28 may be capable of recording one or more alarm messages that are to be played by the sound producing device 12 when the detection device 26 detects smoke or undergoes a test run. The alarm message may be that of a parent's voice instructing their child to wake up, exit the room in the manner the child was taught, and meet outside at the family meeting place. For instance, the alarm message may include “Wake up Johnny, wake up. There is a fire in our house. Please exit your room as I taught you and meet me outside at our family meeting spot.” Such a message, when spoken by a parent, is very effective in awakening and calming sleeping children. Children are more prone to sleep through fire alarms and other sounds because they experience deeper non-rapid eye movement (NREM) sleep during stages three and four. Children have a higher threshold for arousal than adults, but tests have shown that children are more likely to wake up at the sound of their parents voice than to other sounds. Children are also very likely to panic or behave irrationally in his stress crisis situations and may forget how they are supposed to respond.

During use, the smoke detector 10 may be attached to a surface within a room or other structure. In at least one embodiment, the smoke detector 10 may be positioned in a child's room. The fire drill system of the smoke detector 10 enables the smoke detector 10 to be placed into a fire drill mode without having audible alarms activate concurrently with the smoke detector 10 being placed into a fire drill state. Rather, the alarms may be delayed for a time period, referred to as a delay period. In at least one embodiment, the alarms may be delayed for a delay period between about two seconds and about 20 seconds. In another embodiment, the alarms may be delayed for a delay period between about three seconds and about seven seconds. In yet another embodiment, the alarms may be delayed for a delay period of about 5 seconds. By delaying activation of the alarms, a parent, or other person, may activate the fire drill system of the smoke detector 10 in a child's room and leave the room without awakening the sleeping child before the alarms have activated. The parent may then observe the child as the alarms activate to determine whether the alarms are sufficient to awaken the child.

The fire drill system of the smoke detector 10 can be placed into a fire drill mode or a test mode using a single button 30. For instance, the fire drill system may be placed into a fire drill mode by holding and depressing the button 30 for a time period, such as, but not limited to, two seconds. On the other hand, the fire drill system may be placed into a test mode, in which operation of the smoke detector 10 and functionality of the batteries may be tested, by a rapid depression and release of the button 30, which is the same button used to actuate the fire drill system. Use a single button 30 rather than multiple buttons for controlling multiple functions simplifies the smoke detector 10.

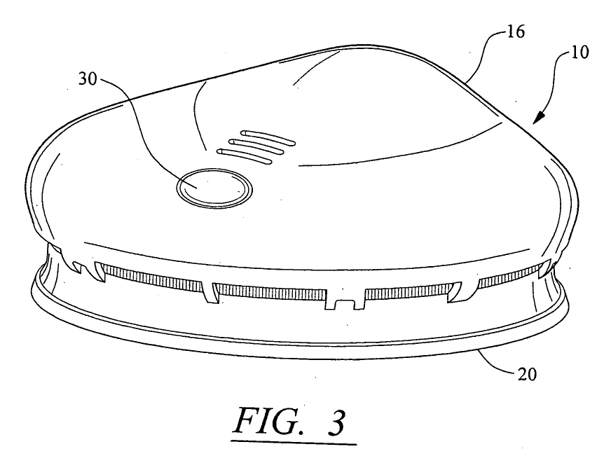

In one particular embodiment of the invention, the smoke detector 10 enables a person to use the fire drill system of the smoke detector 10 to familiarize occupants of a room with an alarm produced by the smoke detector 10. The fire drill may be actuated be depressing a button 30 on the smoke detector 10, as shown in FIG. 3. Once the button is released, the fire drill system begins the delay period in which the audible alarms are delayed from being produced by the sound producing device 12. During the delay period, the smoke detector 10 may emit a visual display indicating that the smoke detector 10 is operating in a fire drill mode. In one embodiment, the smoke detector 10 may produce a blinking light to indicate the smoke detector 10 is operating in the fire drill mode. The blinking light may operate such that a light emitting diode (LED) may be on and emitting light for 500 milliseconds and off, where no light is emitted, for about one second.

Upon conclusion of the delay period, an audible alarm may be produced by the sound producing device 12. The audible alarm may be any alarm capable of alerting occupants of a room that smoke has been detected, such as, but not limited to, a repetitive sound including a single sound or a combination of different sounds, a recorded message, a recorded message from a child's parent, or other appropriate alarm. In at least one embodiment, the audible alarm may be such that it is capable of awakening a sleeping child. Embodiments of the smoke detector 10 may enable a user to record an audible alarm. The recorded message may be played during the fire drill. In one embodiment, upon conclusion of the delay period, a series of temporal tones are produced in a series of beeps. The series of beeps may be followed by the smoke detector 10 playing the recorded message, or vice versa. The smoke detector may alternate between playing the temporal tone and playing the recorded message for the remainder of the fire drill period. In one embodiment, the fire drill period may be about three minutes in length. While the audible alarm is being played, LEDs may emit light in a variety of manners, such as, but not limited to, a continuous emission of light, a sequence of flashing lights or other appropriate manner. In at least one embodiment, a LED may flash on for a time period shorter than during the delay period and have a longer period of time between when the LED is turned on. For instance, a LED may flash on for 200 milliseconds and off for about two seconds. The fire drill may conclude at the pre-established expiration of the fire drill. Alternatively, the fire drill may be turned off before conclusion of the fire drill by depressing the fire drill button.

The foregoing is provided for purposes of illustrating, explaining, and describing embodiments of this invention. Modifications and adaptations to these embodiments will be apparent to those skilled in the art and may be made without departing from the scope or spirit of this invention.

1. A smoke detector, comprising:
a sound producing device for producing an alarm;
a detection device for identifying the presence of smoke; and
a control system for controlling the sound producing device, wherein the control system is capable of cycling the smoke detector through a fire drill, wherein the fire drill includes receiving input to start the fire drill, cycling through a delay period, and emitting an alarm from the sound producing device for a period of time after conclusion of the delay period.

2. The smoke detector of claim 1, wherein the delay period is between about two seconds and about 20 seconds.

3. The smoke detector of claim 2, wherein the delay period is between about three seconds and about seven seconds.

4. The smoke detector of claim 3, wherein the delay period is about five seconds.

5. The smoke detector of claim 1, wherein the alarm produced during the fire drill by the sound producing device is a repetitive sound.

6. The smoke detector of claim 1, wherein the alarm produced during the fire drill by the sound producing device is a recorded human voice.

7. A method of familiarizing occupants of a room with an alarm produced by a smoke detector, comprising:
actuating a fire drill function of a smoke detector formed from a sound producing device for producing an alarm, a detection device for identifying the presence of smoke, and a control system for controlling the sound producing device;
wherein the fire drill function comprises a delay period in which the emission of sounds from the sounds producing device is delayed for a period of time; and
then, after conclusion of the delay period, emitting an audible alarm from the sound producing device.

8. The method of claim 7, wherein the delay period is between about two seconds and about 20 seconds.

9. The method of claim 8, wherein the delay period is between about three seconds and about seven seconds.

10. The method of claim 9, wherein the delay period is about five seconds.

11. The method of claim 7, wherein the alarm produced during the fire drill by the sound producing device is a repetitive sound.

12. The method of claim 7, wherein the alarm produced during the fire drill by the sound producing device is a recorded human voice.

13. The method of claim 7, wherein actuating a fire drill function of a smoke detector comprises depressing a button on a housing of the smoke detector and releasing the button causing a plurality of light emitting diodes to flash on and off throughout the delay period.

14. The method of claim 7, wherein emitting the audible alarm from the sound producing device further comprises causing the light emitting diodes to flash on and off in a sequence that is different than during the delay period.

15. The method of claim 7, wherein emitting the audible alarm from the sound producing device further comprises alternating between a series of beeps and a recorded human voice.
